(19) United States
(12) Patent Application Publication
(10) Pub. No.: US 2025/0108618 A1
(43) Pub. Date: Apr. 3, 2025

(54) IMAGE FORMING APPARATUS

(71) Applicant: CANON KABUSHIKI KAISHA, Tokyo (JP)

(72) Inventor: TOMOHARU KITAJIMA, Ibaraki (JP)

(21) Appl. No.: 18/800,287

(22) Filed: Aug. 12, 2024

(30) Foreign Application Priority Data
Sep. 29, 2023 (JP) 2023-170077

(51) Int. Cl. B41J 2/17; B41J 2/14

(52) U.S. Cl. CPC B41J 2/1714; B41J 2002/14403

(57) ABSTRACT

An image forming apparatus includes: a recording portion configured to eject ink onto a sheet to form an image; a conveying portion facing the recording portion, and configured to convey the sheet; and an exhaust fan unit attached to an apparatus body, the exhaust fan unit being detachable from the apparatus body, in which the exhaust fan unit includes: an exterior cover having an exhaust port through which air passes to the outside; an exhaust fan configured to generate an air flow toward the outside; a filter; and a case configured to integrally hold the exterior cover, the exhaust fan, and the filter so that the exhaust fan is disposed between the exterior cover and the filter.

### BACKGROUND OF THE INVENTION

### Field of the Invention

The present invention relates to an image forming apparatus that forms an image using an inkjet method, such as a printing machine, a copying machine, or a printer.

### Description of the Related Art

As a configuration for capturing contaminants inside an image forming apparatus with a dust-collecting filter to discharge clean air, a technique in which a filter is disposed inside an exhaust fan is disclosed (see Japanese Patent Application Laid-Open No. 4-291286). By placing the filter that captures contaminants (e.g., ink mist) in the machine inside the exhaust fan as described above, the exhaust fan is protected from the contaminants in the machine.

In the above-described related art, the filter is a consumable item having a limited capacity to capture contaminants. This makes it necessary to replace the filter.

However, in the above-described related art, in a hierarchical configuration from an exterior cover to the filter of the image forming apparatus, the exterior cover, an exhaust fan, and the filter are arranged in this order. Therefore, when replacing the filter, it is necessary to remove the exterior cover, the exhaust fan, and the filter in this order and attach the same in the reverse order, and there is a problem that replacement work takes time and effort.

### SUMMARY OF THE INVENTION

As a typical configuration of the present invention, an image forming apparatus includes: a recording portion configured to eject ink onto a sheet to form an image; a conveying portion facing the recording portion, and configured to convey the sheet; and an exhaust fan unit attached to an apparatus body, the exhaust fan unit being detachable from the apparatus body, in which the exhaust fan unit includes: an exterior cover having an exhaust port through which air passes to the outside; an exhaust fan configured to generate an air flow toward the outside; a filter; and a case configured to integrally hold the exterior cover, the exhaust fan, and the filter so that the exhaust fan is disposed between the exterior cover and the filter.

Further features of the present invention will become apparent from the following description of exemplary embodiments with reference to the attached drawings.

### BRIEF DESCRIPTION OF THE DRAWINGS

FIG. 1 is a schematic cross-sectional view illustrating a schematic configuration of an image forming apparatus;

FIG. 2 is a schematic cross-sectional view of a print module;

FIG. 3 is a perspective view illustrating a part of an exterior member of the print module;

FIG. 4 is a perspective view illustrating a configuration of an exhaust fan unit;

FIGS. 5A to 5C are perspective views illustrating the configuration of the exhaust fan unit;

FIG. 6 is a schematic diagram illustrating a filter holding configuration;

FIG. 7 is a schematic cross-sectional view of the exhaust fan unit;

FIG. 8 is a perspective view of the print module as viewed obliquely from the front-right side;

FIG. 9 is a perspective view of an attachment portion of the exhaust fan unit;

FIG. 10 is a perspective view of the attachment portion of the exhaust fan unit on the body side; and

FIG. 11 is a perspective view of the exhaust fan unit.

### DESCRIPTION OF THE EMBODIMENTS

Hereinafter, an embodiment of an image forming apparatus according to the present invention will be specifically described with reference to the drawings. Note that dimensions, materials, relative positions, and the like of components of the image forming apparatus described below do not limit the scope of the present invention unless otherwise specified. In addition, the same reference numerals in the drawings denote the same configurations or functions, and redundant description thereof will be appropriately omitted.

### Image Forming Apparatus

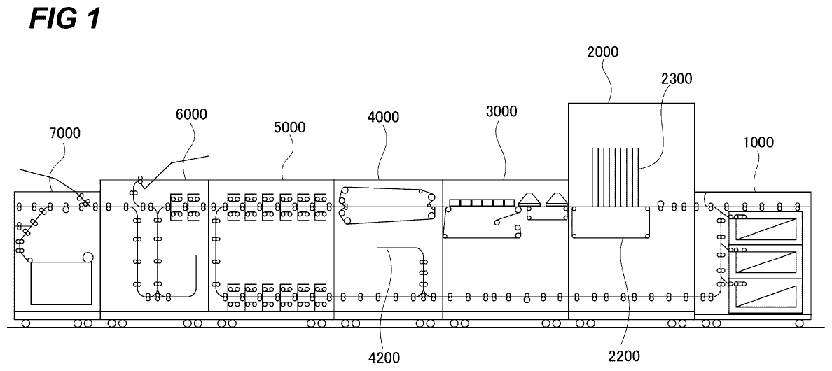

A schematic configuration of an image forming apparatus will be described with reference to FIG. 1. FIG. 1 is a schematic diagram illustrating a configuration of an image forming apparatus. The image forming apparatus illustrated in FIG. 1 is an example of an inkjet image forming apparatus that forms an image using an inkjet method.

The image forming apparatus processes paper (recording medium) fed from a sheet feeding module 1000 through a print module 2000, a drying module 3000, a fixing module 4000, a cooling module 5000, an inverting module 6000, and a discharged sheet stacking module 7000 in this order. An image is formed on the paper fed from the sheet feeding module 1000 by the print module 2000. The drying module 3000 is a unit that reduces an amount of liquid contained in ink to improve fixability between the paper and the ink, and the fixing module 4000 heats the sheet to soften the applied ink. The cooling module 5000 cools the fixed paper to solidify the softened ink, and suppresses a change in paper temperature downstream of the cooling module. The inverting module 6000 adjusts the orientation of the paper to a desired orientation. The discharged sheet stacking module 7000 aligns and stacks the printed paper.

At the time of duplex printing, the paper is U-turned by the cooling module 5000 and conveyed toward the print module, and the front and back sides and the front and back directions of the paper are changed by an inverting device 4200 provided in the fixing module 4000. Thereafter, the paper is conveyed back to the print module 2000 through the drying module 3000 and a duplex conveying path of the sheet feeding module 1000 to perform printing on the back side.

### Print Module

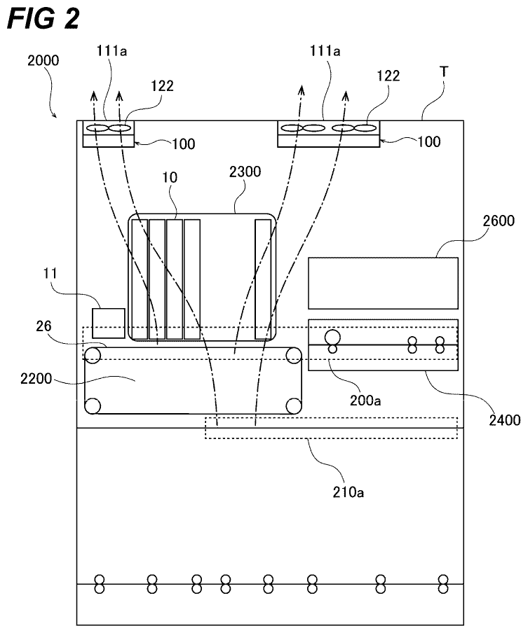

A configuration of the print module 2000 will be described with reference to FIG. 2. FIG. 2 is a schematic cross-sectional view of the print module 2000.

The print module 2000 is an image forming portion that performs recording processing on paper (recording medium) as a conveyed sheet from above using a recording head 10 to form an image on the paper. The print module 2000 includes a pre-image formation registration correction portion 2400, a print belt unit 2200 as a conveying portion, a recording portion 2300, and a head maintenance mechanism portion 2600. The paper is conveyed in a sucked state by the print belt unit 2200, thereby securing a clearance from the recording head.

The paper conveyed from the sheet feeding module 1000 is conveyed to the print belt unit 2200 after the inclination and position of the paper are corrected by the pre-image formation registration correction portion 2400. The recording portion 2300 is disposed at a position facing the print belt unit 2200 with respect to the conveyance path. The recording portion 2300 performs recording processing (printing) on paper as a conveyed sheet from above using the recording head 10 to form an image on the paper. For the conveyance of the paper in the recording portion 2300, the print belt unit 2200 that conveys the paper in a sucked and adsorbed manner is disposed so that the paper conveyance behavior is stabilized directly below the recording head 10. The print belt unit 2200 has a paper conveyance surface 26 that is a sheet conveyance surface. The paper conveyed on the paper conveyance surface 26 is conveyed in a state where a clearance from the recording head 10 is secured. Concerning the recording head 10, as described above, a plurality of recording heads is arranged along a paper conveyance direction, and ejects the ink at appropriate ejection timings onto the conveyed paper to form an image. The plurality of recording heads 10 is arranged along the conveyance direction. In this example, a total of five line-type recording heads corresponding to a reaction liquid in addition to four colors of yellow (Y), magenta (M), cyan (C), and black (Bk) are provided.

An in-line scanner unit 11 that reads paper with an image on the paper conveyance surface 26 of the print belt is installed downstream of the recording head 10 to inspect the image immediately after the ink is applied. When an image defect such as an ink ejection failure is detected as an ink ejection hole is blocked, the apparatus is immediately stopped to minimize the production of defective products. The in-line scanner unit 11 is a unit that not only detects an ink ejection state but also reads an image formed on paper by the recording portion during printing, detects a deviation of the image or a density, and corrects the printing.

The head maintenance mechanism portion 2600 is disposed upstream of the recording portion 2300. The head maintenance mechanism portion 2600 has a two-layer structure including a cap tray (not illustrated) at an upper stage and a cleaning tray (not illustrated) at a lower stage. The cap tray at the upper stage includes a cap mechanism that caps an ink ejection surface of the recording head 10. The cleaning tray located at the lower stage cleans the ink ejection surface of the recording head 10 by wiping or vacuuming.

While the operation of the body is stopped, the cap tray is directly below the recording portion 2300, and the recording head 10 is capped by landing on a cap (not illustrated) in the cap tray to prevent the ink ejection surface of the recording head 10 from being dried. According to a print start command from a controller (not illustrated), the recording head 10 is first moves up to an upper retraction position to be spaced apart from the cap tray, then the cap tray retracts to a right retraction position, and thereafter the recording head 10 moves down to a printing position to perform a printing operation. According to a print end command, when the recording head 10 moves up to the upper retraction position, and thereafter the cap tray moves from the retraction position to a position directly below the recording portion 2300, the recording head 10 is capped by moving down and landing on the cap tray, and reaches a stop state then.

Even during printing, when a predetermined continuous operating time is reached, a cleaning command is issued from the controller (not illustrated). According to the cleaning command, after the recording head 10 moves up to the upper retraction position, the cleaning tray located at the lower stage of the head maintenance mechanism portion 2600 moves directly below the recording portion 2300. Thereafter, the recording head 10 moves down and lands on the cleaning tray, and a cleaning operation such as wiping or vacuuming is performed. After the cleaning of the head is completed, the recording head 10 moves up to the upper retraction position, the cleaning tray moves from the position directly below the recording portion 2300 to the right retraction position, and the recording head 10 moves down to the printing position to resume the printing. In a case where the printing is not resumed after the cleaning of the head, the recording head 10 moves up to the upper retraction position after the cleaning of the head is completed, the cleaning tray moves from the position directly below the recording portion 2300 to the retraction position, and the cap tray moves from the retraction position to the position directly below the recording portion 2300. Then, the recording head 10 is capped by moving down and lands on the cap tray, and reaches a stop state then. The cleaning of the head during the printing operation may be performed after paper circulating in the machine is completely subjected to the printing processing and the supply of new paper is stopped, or may be performed by temporarily stopping the printing operation even in a state where there is paper in circulation.

Note that the number of colors and the number of recording heads in the image forming apparatus are not limited to five. Further, as the ink jet method, a method using a heat generating element, a method using a piezoelectric element, a method using an electrostatic element, a method using an MEMS element, or the like can be adopted.

### Air Flow in Body of Print Module

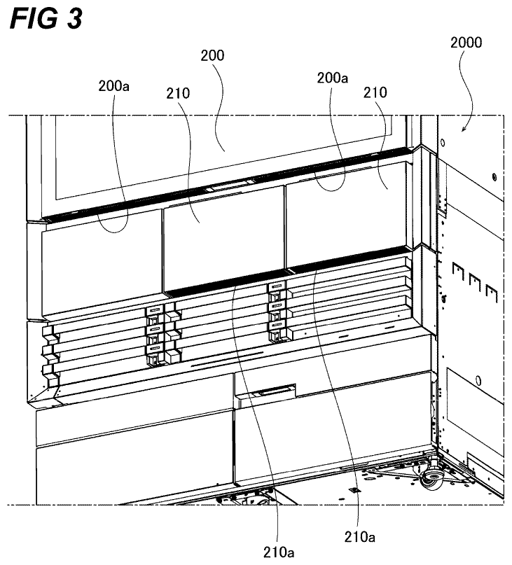

Next, an air flow in the body of the print module 2000 (an air flow from the paper conveyance surface to the top surface of the body) in the present embodiment will be described with reference to FIGS. 2 and 3. FIG. 2 is a schematic cross-sectional view of the print module 2000. An arrow in FIG. 2 represents an air flow in the body of the print module 2000. FIG. 3 is a perspective view illustrating a part of an exterior member of the print module 2000.

In an inkjet image forming apparatus, an air flow is generally formed in a body for the following two purposes.

The first is a countermeasure against dew condensation at an ink ejection portion in the recording head 10. The ink circulating inside the print module 2000 is managed at about 28° C., and the ink ejection portion is also guided to the ink temperature. In the print module 2000, moisture generated from paper or air flowing in as the paper is conveyed may come into contact with the ink ejection portion, causing dew condensation on the head surface, which hinders ink ejection. For this reason, an air flow indicated by an arrow in FIG. 2 is formed in the vicinity of the recording head 10 to keep the temperature around the ink ejection portion at 30° C. or lower to prevent dew condensation on the ink ejection portion.

The second is the removal of ink mist. In the recording portion 2300 where ink is ejected to form an image, when main droplets of the ink are ejected, satellite droplets smaller than the main droplets may be generated accompanying the main droplets or smaller spray-like ink mist may be generated, and some of the satellite droplets and smaller spray-like mist may float around the recording portion 2300. Hereinafter, the satellite droplets and the smaller spray-like droplets will be collectively referred to as ink mist. If the ink mist adheres to a surface of the recording head 10 through which an ejection orifice is formed, an ejection failure may occur and the ink landing accuracy may decrease. In addition, the ink mist may adhere to other components of the image forming apparatus, resulting in a deterioration in durability of the image forming apparatus. For this reason, an air flow is formed in the vicinity of the recording head 10 so that the ink mist does not stay in the ink ejection portion.

In the present embodiment, as illustrated in FIG. 2, an exhaust port 111a for discharging air to the outside is provided in an exterior cover 111 of a top surface T of the print module 2000 to form an air flow directed upward from the recording portion 2300. As illustrated in FIG. 3, an intake port 200a for introducing air from the outside is provided in the exterior member 200 in the vicinity of the paper conveyance surface 26 of the print module 2000 to form an air flow for introducing air outside the image forming apparatus. The exterior member 200 includes a frame and a transparent cover surrounded by the frame. The exterior member 200 is opened and closed with its upper end as a pivot axis. The intake port 200a is provided at a lower end of the exterior member 200. A part of the exterior member 200 is positioned below the paper conveyance surface 26 in the vertical direction. Therefore, the intake port 200a is positioned below the paper conveyance surface 26. In the print module 2000, an intake port 210a is further provided separately from the intake port 200a. The intake port 210a is also provided in an exterior member 210 of the print module 2000. The exterior member 210 is entirely positioned below the paper conveyance surface 26 in the vertical direction. By forming the air flows (arrows in FIG. 2) from the intake ports 200a and 210a toward the exhaust port 111a inside the print module 2000, air around the ink ejection portion is replaced with the outside air to cool the ink ejection portion, and prevent contamination caused when the ink mist adheres to the periphery of the ink ejection portion.

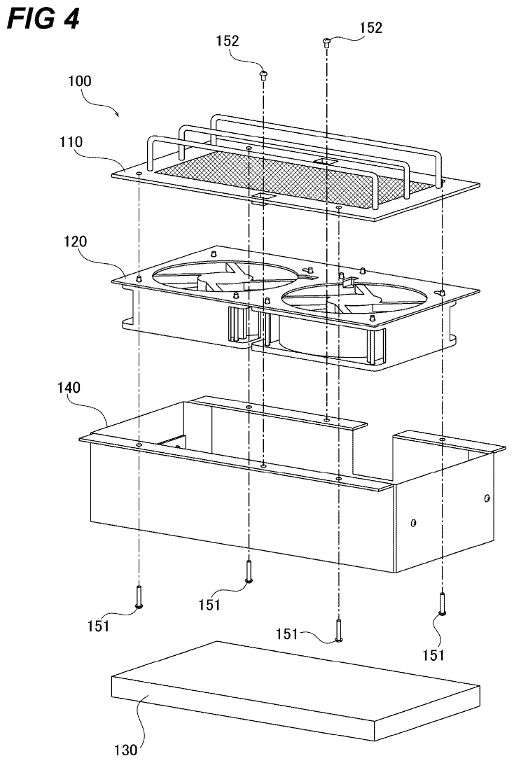

However, since the ink mist is contained in the air flow illustrated in FIG. 2 as described above, if this air is discharged as it is to the outside of the image forming apparatus, the environment in which the image forming apparatus is installed will be contaminated with the ink mist. Therefore, in the present embodiment, a filter 130 (see FIG. 4) is provided in an air flow passage, specifically, directly before a fan motor 122 as an exhaust fan to capture the ink mist and prevent leakage of the ink mist to the outside of the image forming apparatus.

Here, the filter 130 is a consumable item having a limited capacity to capture contaminants. Therefore, it is necessary to replace the filter 130. However, in the hierarchical configuration from the exterior cover to the filter 130 of the image forming apparatus, since the exterior cover, the fan motor 122, and the filter 130 are arranged in this order, replacement work takes time and effort.

At this point, in the print module 2000 of the present embodiment, an exhaust fan unit 100, in which the exterior cover 111 having the exhaust port 111a, the fan motor 122, and the filter 130 are integrally formed, is attachably and detachably attached to the apparatus body of the print module 2000.

In particular, in the image forming apparatus having the configuration illustrated in FIG. 1, the exhaust fan unit 100 has a large longitudinal dimension of about 500 mm. Therefore, it is more efficient to handle the attachment/detachment of the exterior cover 111, the fan motor 122, and the filter 130 in an integrated state to/from the body.

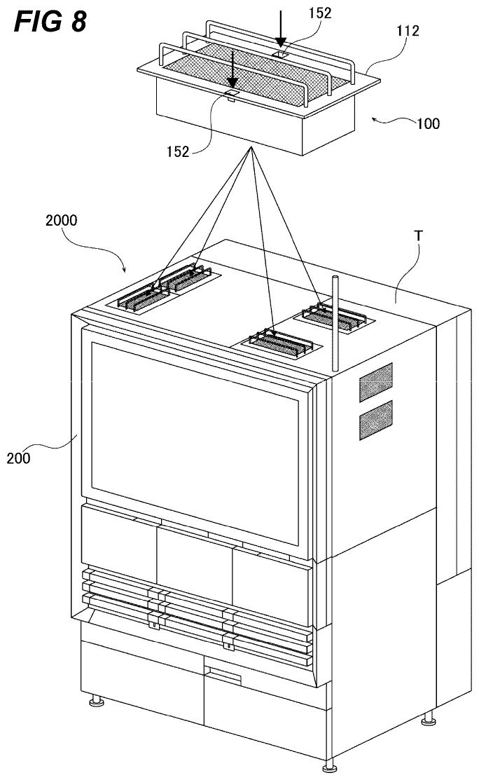

In the present embodiment, as illustrated in FIGS. 2 and 8, it is exemplified that the exhaust fan unit 100 is disposed on the top surface T of the apparatus body of the print module 2000. However, the arrangement of the exhaust fan unit 100 is not limited thereto, and the exhaust fan unit 100 only needs to be disposed above the paper conveyance surface 26 of the print belt unit 2200.

### Configuration of Exhaust Fan Unit

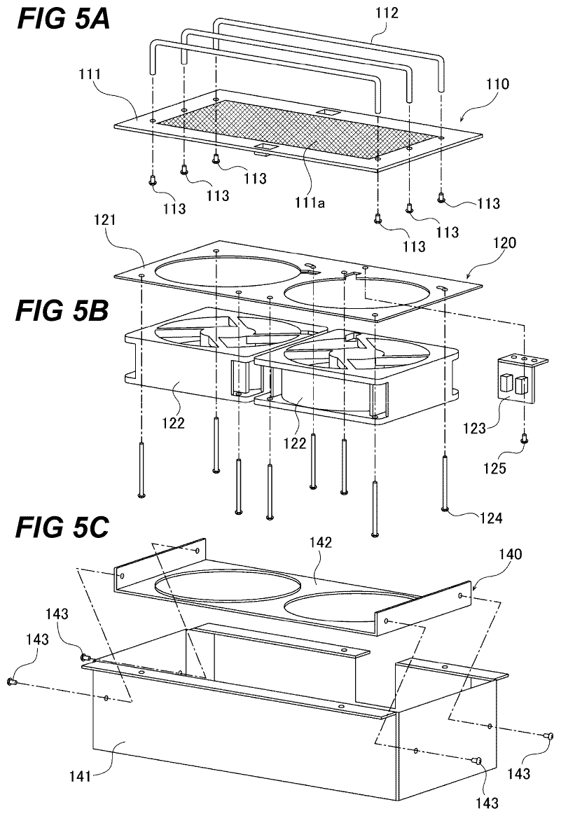

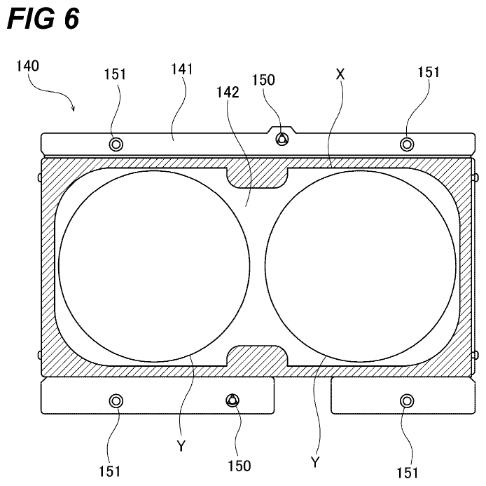

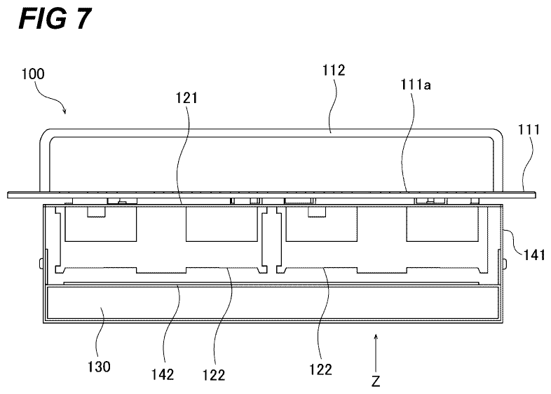

Next, a configuration of the exhaust fan unit 100 will be described with reference to FIGS. 4, 5A to 5C, 6, and 7. FIG. 4 is a perspective view illustrating a configuration of the exhaust fan unit 100. FIG. 4 is a perspective view illustrating an exterior cover assembly 110, a fan assembly 120, a filter 130, and a fan case assembly 140 constituting the exhaust fan unit 100. FIG. 5A is a perspective view illustrating a configuration of the exterior cover assembly 110 in the exhaust fan unit. FIG. 5B is a perspective view illustrating a configuration of the fan assembly 120 in the exhaust fan unit. FIG. 5C is a perspective view illustrating a configuration of the fan case assembly 140 in the exhaust fan unit. FIG. 6 is a schematic diagram illustrating a configuration in which the filter is held in the exhaust fan unit 100. FIG. 7 is a cross-sectional view of the exhaust fan unit 100.

Although the exhaust fan unit 100 described here has a configuration in which two fan motors are connected to each other, the basic configuration requirements are similar even if the number of fan motors is changed, and are applied regardless of the number of fan motors.

In the present embodiment, three wire members are used for the exhaust fan unit 100, but the number of wire members is not limited thereto, and the basic configuration requirements are similar regardless of the number of wire members.

As illustrated in FIGS. 4 and 5A to 5C, the exhaust fan unit 100 includes an exterior cover assembly 110, a fan assembly 120, a filter 130, and a fan case assembly 140. In the exterior cover assembly 110, a wire member 112 is assembled to an exterior cover 111. In the fan assembly 120, a fan motor 122 and a fan support plate 121 are fixed to and integrated with each other by screws. The fan motor 122 is an exhaust fan that generates an air flow toward the outside. The fan case assembly 140 includes a unit housing 141 and a filter support plate 142. As a method of assembling them, the fan assembly 120 is assembled to the fan case assembly 140 from one side (exterior cover side), and the filter 130 is attached to the fan case assembly 140 by compressing the filter 130 from the other side (side opposite to the exterior cover).

By attaching the filter 130 to the fan case assembly 140, the filter 130 is disposed close to the inside of the fan motor 122. The filter 130 adsorbs and captures contaminants inside the apparatus.

In the exhaust fan unit 100, the fan case assembly 140 and the fan assembly 120 are fixed together to the exterior cover assembly 110 by screws 151 from the inner surface side opposite to an external appearance surface of the exterior cover assembly 110. As a result, the screws used in the respective subassemblies of the exhaust fan unit 100 are not visible from the external appearance. This is to prevent access to anything other than the fixing screws 152 that fix the exhaust fan unit 100 to the print module 2000 when detaching the exhaust fan unit 100 assembled to the print module 2000. As a result, it is possible to reduce the time required for maintenance work.

FIG. 5A illustrates a detailed configuration of the exterior cover assembly 110. The exterior cover assembly 110 includes an exterior cover 111 painted in an exterior color with a louver forming an exhaust port 111a, and a wire member 112, which are fixed to each other with screws. The louver shape of the exhaust port 111a also includes a mesh shape. Concerning the image forming apparatus whose body height is nearly 2 m, since a user cannot see the top surface of the apparatus, it is difficult to recognize that there is an exhaust port, and there is a concern that an object may be placed on the top surface by mistake and the exhaust port 111a may be blocked. In order to prevent the exhaust port 111a from being blocked even if an object is placed on the top surface by mistake, a plurality of (here, three) wire members 112 is disposed at intervals of about 30 to 80 mm to cover an opening region of the exhaust port 111a. The wire member 112 is disposed on the external appearance surface side of the exterior cover 111, and is fixed to the exterior cover 111 with screws 113 from the inner surface side of the exterior cover 111. The wire member has a portion extending along an exterior surface of the exterior cover 111 and portions extending from both ends of the portion toward the exterior surface. That is, the wire member 112 has a U-shape. The distance between the wire member 112 and the exterior cover 111 is set to 25 mm or more to allow exhaust from the top surface through the exhaust port 111a. The wire member 112 also serves as a handle when the exhaust fan unit 100 is separated from the print module 2000. Therefore, the distance between the exterior surface of the exterior cover 111 and the portion of the wire member 112 extending along the exterior surface of the exterior cover 111 is set to a distance that allows a human hand to enter.

FIG. 5B illustrates a detailed configuration of the fan assembly 120. The fan assembly 120 is disposed close to the inside of the exterior cover 111, and generates air from the inside of the apparatus toward the outside of the apparatus. The fan assembly 120 is formed by fixing a fan motor 122, a fan support plate 121, and a panel mount support plate 123 with screws 124 and 125. The fan motor 122 is disposed so that a bundle of wires (not illustrated) from the fan motor 122 gathers at a central portion of the fan assembly 120 in the longitudinal direction, and is connected together to the panel mount support plate 123. The screw 124, which fixes the fan motor 122 to the fan support plate 121, penetrates the fan motor 122, and is fixed to the fan support plate 121. The screw 125, which fixes the panel mount support plate 123 to the fan support plate 121, is driven from the same direction as the screw 124 of the fan motor 122 from the viewpoint of assembly workability, and the panel mount support plate 123 is fixed to the fan support plate 121.

FIG. 5C illustrates a detailed configuration of the fan case assembly 140. The fan case assembly 140 is formed by fixing a unit housing 141 and a filter support plate 142 with screws 143. The unit housing 141 has a first air passage hole X (see FIG. 6) forming an air passage of the fan motor 122. The filter support plate 142 has a second air passage hole Y (see FIG. 6) forming an air passage of the fan motor 122. The unit housing 141 and the filter support plate 142 hold the filter 130 by sandwiching both sides of the filter 130 therebetween. In other words, the unit housing 141 functions as a first holding portion that holds one surface side of the filter 130. The filter support plate 142 is provided closer to the exhaust fan (the fan assembly 120) than the unit housing 141, and functions as a second holding portion that holds the other surface side opposite to the one surface side of the filter.

The air passage holes formed in the unit housing 141 and the filter support plate 142 are required to prevent the filter 130 from falling from the fan case assembly 140 when the filter 130 is attached therebetween. In addition, it is required that the filter 130 does not come into contact with the fan motor 122, which is a rotating object.

FIG. 6 illustrates the fan case assembly 140 as viewed from the direction in which the filter 130 is attached. In the drawing, X represents an air passage hole provided in the unit housing 141, and Y represents an air passage hole provided in the filter support plate 142. The air passage hole X of the unit housing 141 that holds the lower side of the filter 130 in the direction of gravity is determined, in consideration of the rigidity of the filter 130 at the time of compression, in such a manner that, when the exhaust fan unit 100 is attached to the print module 2000, the unit housing 141 covers the four side end portions (shaded portions in the drawing) of the filter 130 to prevent the filter 130 from falling in the direction of gravity, and the unit housing 141 covers the filter 130 in an area that does not hinder filter exchangeability. The air passage hole Y of the filter support plate 142 has a minimum area that does not damage the air passage of the fan motor 122. An opening area of the air passage hole X of the unit housing 141 and an opening area of the air passage hole Y of the filter support plate 142 have a relationship represented by the following formula 1. That is, the opening area of the air passage hole X is equal to or larger than the opening area of the air passage hole Y.

unit housing 141≥filter support plate 142

X≥Y [Formula 1]

FIG. 7 illustrates a cross section of the exhaust fan unit 100. When the filter 130 is attached to the fan case assembly 140, the filter 130 is inserted in the Z direction from the inner surface side opposite to the external appearance surface of the exterior cover 111. The filter 130 is an elastic body, and the filter 130 is compressed to be attached or detached between the unit housing 141 and the filter support plate 142 from the first air passage hole X. That is, the filter 130 is pressed from the first air passage hole X toward the fan motor while being compressed for attachment.

In order to prevent the filter 130 from coming into contact with the fan motor 122, a predetermined gap (here, 1 mm or more) can be formed between the filter support plate 142 and the fan motor 122. In addition, in a case where a plurality of fan motors 122 is used for the fan assembly 120, if the filter support plate 142 continues between the plurality of fan motors 122 within a range not obstructing the air passages of the fan motors 122, the filter support plate 142 can more reliably prevent contact between the filter 130 and the fan motors 122. In other words, as illustrated in FIG. 6, the filter support plate 142 has a second air passage hole Y for each fan motor 122 within a range not obstructing the air passage of the fan motor 122. As a result, the filter support plate 142 between the air passage holes Y can more reliably prevent contact between the filter 130 and the fan motors 122.

### Attachment and Detachment of Exhaust Fan Unit

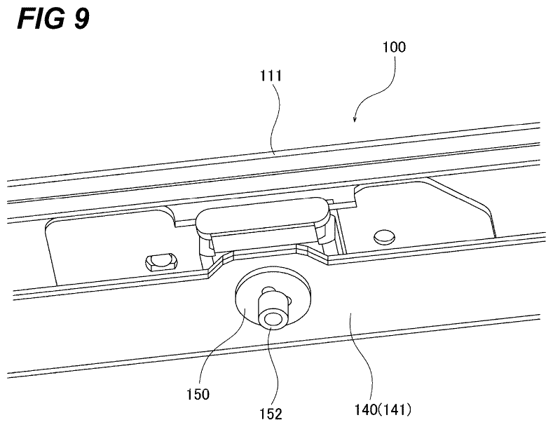

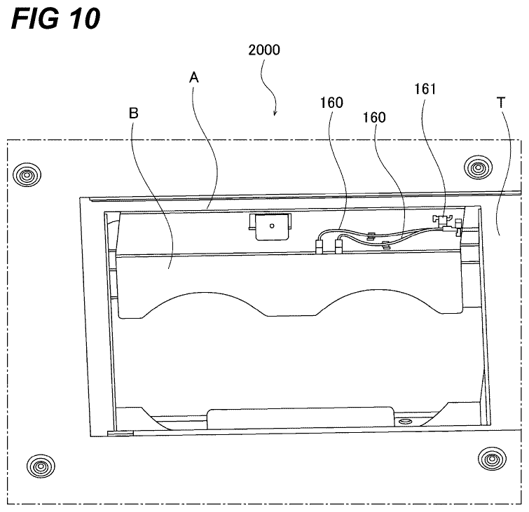

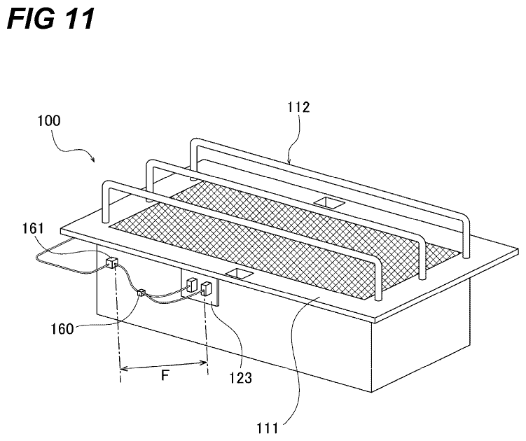

The attachment and detachment of the exhaust fan unit 100 to and from the print module 2000 will be described with reference to FIGS. 8, 9, 10, and 11. FIG. 8 is a perspective view of the print module 2000 as viewed obliquely from the front-right side. FIG. 9 is a perspective view of a main part illustrating a MO washer attached to the exhaust fan unit 100. FIG. 10 is a perspective view of an attachment portion of the exhaust fan unit 100 on the print module 2000 side. FIG. 11 is a perspective view of the exhaust fan unit 100.

In the present embodiment, it is exemplified that the exhaust fan unit 100 is disposed on the top surface T of the print module 2000. The ink mist originates from the ink ejection portion of the recording head 10 disposed above the paper conveyance surface 26. Therefore, the arrangement of the exhaust fan unit 100 including an exhaust port is not limited to the top surface of the print module 2000, and may be, for example, a side surface or a back surface of the print module 2000 as long as the exhaust fan unit 100 is located above the paper conveyance surface 26 (print belt unit 2200) in order to prevent adhesion of mist to paper.

As illustrated in FIG. 8, four exhaust fan units 100, in each of which the exterior cover 111, the fan motor 122, and the filter 130 are integrated, are attached to the top surface T of the print module 2000, and are arranged to correspond to air flows indicated by the arrows in FIG. 2. Each exhaust fan unit 100 is fixed to the print module 2000 by two fixing screws 152 (arrow portions in FIG. 8) seen from the external appearance side of the exhaust fan unit 100. By loosening the two fixing screws 152, the exhaust fan unit 100 can be detached from the print module 2000. At this time, the exhaust fan unit 100 can be pulled out upward from the top surface T of the print module 2000 while holding the U-shaped wire member 112 attached to the exterior cover 111.

When the exhaust fan unit 100 is pulled out from the top surface T of the print module 2000, an installation hole A of the print module 2000 communicating from the outside of the apparatus to the inside of the apparatus becomes opened as illustrated in FIG. 10. The installation hole A is an opening corresponding to an area of the external appearance surface of the exterior cover 111 of the exhaust fan unit 100. Therefore, depending on the angle of the exhaust fan unit 100 with respect to the installation hole A, the exhaust fan unit 100 may fall into the apparatus from the installation hole A. For this reason, a landing surface B on which the exhaust fan unit 100 lands is provided in the installation hole A. The landing surface B has a shape set to cover the exhaust fan unit 100 in a projective manner over as large an area as possible, and not to obstruct the air passage of the exhaust fan unit 100. As a result, no matter what angle the exhaust fan unit 100 enters the apparatus from the installation hole A, the exhaust fan unit 100 is always caught somewhere on the landing surface B and prevented from falling into the apparatus from the installation hole A.

In addition, if an object falls through the installation hole A, it is difficult to find the falling object. Such an object is, for example, the fixing screw 152 that fixes the exhaust fan unit 100 to the print module 2000. Therefore, in the present embodiment, a washer 150 having an inner diameter smaller than an outer diameter of the fixing screw 152 and having an engagement portion (not illustrated) to be engaged with the fixing screw 152 is provided. As illustrated in FIG. 9, the fixing screw 152 is fixed to the exhaust fan unit 100 by the washer 150. Specifically, the washer 150 functions to prevent the fixing screw 152 from coming off the exhaust fan unit 100 as the engagement portion is engaged with a groove of the fixing screw 152. As a result, even when the fixing screw 152 is rotated, the fixing screw 152 does not come off the exhaust fan unit 100, making it possible to prevent the dropping of the screw or the like.

A bundle of wires 160 connected to the exhaust fan unit 100 will be described with reference to FIG. 11. The exhaust fan unit 100 is pulled out from the top surface T of the print module 2000. At this time, the bundle of wires 160 connected to the panel mount support plate 123 provided on the side surface of the exhaust fan unit 100 is pulled out together with the exhaust fan unit 100. The exhaust fan unit 100 pulled out from the print module 2000 is temporarily placed on the top surface T of the print module 2000, for example, with a sheet laid thereon. Then, a connector of the bundle of wires 160 is removed from the panel mount support plate 123 of the exhaust fan unit 100 to completely separate the exhaust fan unit 100 from the print module 2000. Thereafter, the exhaust fan unit 100 is carried to a work table to replace the filter 130. The position range for temporarily placing the exhaust fan unit 100 on the top surface T is restricted by the length of the bundle of wires 160. The length of the bundle of wires 160 is restricted by a reuse band 161. The bundle of wires 160 is a free bundle of wires having a length F (here, 120 [mm]) in FIG. 11 from the reuse band 161 fixed to the print module 2000 to the connector with the reuse band 161 as a starting point. The lower limit of the length F of the bundle of wires 160 is a length that allows the exhaust fan unit 100 to be placed on the top surface T in a state where the bundle of wires 160 is connected. The upper limit of the length F of the bundle of wires 160 is a length that prevents the bundle of wires 160 from being pinched by something on a unit movement line or a length that prevents the bundle of wires 160 from touching an edge of a metal plate and being broken or coating-torn, even when the exhaust fan unit 100 is installed in the installation hole A of the top surface T.

The operation of replacing the filter 130 may be performed in a state where the exhaust fan unit 100 is temporarily placed on the top surface T. Further, the unit that electrically connects the print module 2000 and the exhaust fan unit 100 is not limited to the bundle of wires 160, and the print module 2000 and the exhaust fan unit 100 may be automatically connected to each other, for example, by attaching and detaching the unit using a drawer.

As described above, according to the present embodiment, the exhaust fan unit 100, in which the exterior cover 111, the fan motor 122, and the filter 130 are integrally formed, is attachably and detachably attached to the print module 2000. As a result, the filter 130 can be easily replaced.

When the fixing screw 152 fixed to the exhaust fan unit 100 is loosened by the washer 150, the exhaust fan unit 100 can be easily taken out from the print module 2000. In addition, the filter 130, which is an elastic body, can be attached to the exhaust fan unit 100 by compressing the filter 130, or can be easily replaced by detaching the filter 130 from the exhaust fan unit 100.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-170077, filed Sep. 29, 2023, which is hereby incorporated by reference herein in its entirety.

What is claimed is:

1. An image forming apparatus comprising:
a recording portion configured to eject ink onto a sheet to form an image;
a conveying portion facing the recording portion, and configured to convey the sheet; and
an exhaust fan unit attached to an apparatus body, the exhaust fan unit being detachable from the apparatus body,
wherein the exhaust fan unit includes:
an exterior cover having an exhaust port through which air passes to the outside;
an exhaust fan configured to generate an air flow toward the outside;
a filter; and
a case configured to integrally hold the exterior cover, the exhaust fan, and the filter so that the exhaust fan is disposed between the exterior cover and the filter.

2. The image forming apparatus according to claim 1, wherein
the exhaust fan unit includes a wire member disposed outside the exterior cover to cover the exhaust port of the exterior cover, and
the wire member includes a first portion extending in a direction along an exterior surface of the exterior cover, a second portion extending from a first end of the first portion toward the exterior surface, and a third portion extending from a second end of the first portion toward the exterior surface.

3. The image forming apparatus according to claim 1, wherein the exhaust fan unit is provided above a sheet conveyance surface of the conveying portion in a vertical direction.

4. The image forming apparatus according to claim 1, wherein the exhaust fan unit is disposed on a top surface of the apparatus body.

5. The image forming apparatus according to claim 1, further comprising:
an exterior member having an intake port through which air is introduced from the outside,
wherein the intake port of the exterior member is disposed below a sheet conveyance surface of the conveying portion in a vertical direction.

6. The image forming apparatus according to claim 1, wherein
the case includes:
a first holding portion having a first air passage hole, and configured to hold the filter with a first surface side of the filter; and
a second holding portion having a second air passage hole, disposed between the exhaust fan and the first holding portion, and configured to hold the filter with a second surface side of the filter, the second surface side being opposite to the first surface side,
the first holding portion and the second holding portion hold the filter, with both surfaces of the filter sandwiched therebetween, and
an opening area of the first air passage hole is equal to or larger than an opening area of the second air passage hole.

7. The image forming apparatus according to claim 6, wherein the exhaust fan is disposed between the exterior cover and the second holding portion of the case with a gap from the second holding portion of the case.

8. The image forming apparatus according to claim 1, wherein the filter includes an elastic body, and the filter is held in the case in a compressed state.

9. The image forming apparatus according to claim 1, wherein the case and the exhaust fan are integrally fixed to the exterior cover by a screw inserted from an inner side of the exterior cover.

10. The image forming apparatus according to claim 1, wherein
the exhaust fan unit includes a fixing screw fixing the exhaust fan unit to the image forming apparatus, and a washer having an inner diameter smaller than an outer diameter of the fixing screw and having an engagement portion engaged with the fixing screw, and
the washer functions to prevent the fixing screw from coming off the exhaust fan unit as the engagement portion is engaged with a groove of the fixing screw.

11. The image forming apparatus according to claim 1, wherein
the image forming apparatus has an installation hole communicating from the outside of the apparatus to the inside of the apparatus, and a landing surface provided in the installation hole for the exhaust fan unit to land thereon,
the installation hole is an opening corresponding to an area of an external appearance surface of the exterior cover of the exhaust fan unit, and
the landing surface has a shape to covers the exhaust fan unit and not to obstruct an air passage of the exhaust fan unit.

12. The image forming apparatus according to claim 1, wherein the exhaust port of the exterior cover has a louver shape.

13. The image forming apparatus according to claim 2, wherein a distance between the exterior surface of the exterior cover and the first portion of the wire member is 25 mm or more.

14. The image forming apparatus according to claim 2, wherein an operator's hand is allowed to be put between the exterior surface of the exterior cover and the first portion of the wire member.

15. The image forming apparatus according to claim 1, wherein
the image forming apparatus includes:
a first module including the recording portion and the conveying portion; and
a second module connected to the first module in a conveyance direction in which the sheet is conveyed by the conveying portion, and
the exhaust fan unit is attached to the first module.

16. The image forming apparatus according to claim 1, wherein the exhaust fan unit sucks ink mist originating from the recording portion.
